(19) United States
(12) Patent Application Publication
(10) Pub. No.: US 2020/0291673 A1
(43) Pub. Date: Sep. 17, 2020

(54) FENCE PANEL COMPRISING COMPONENTS HAVING A CORROSION-RESISTANT COATINGS AND RELATED METHOD FOR FORMING SAME

(71) Applicant: Alain Comte, Notre-Dame (CA)

(72) Inventor: Alain Comte, Notre-Dame (CA)

(21) Appl. No.: 16/352,418

(22) Filed: Mar. 13, 2019

(51) Int. Cl. E04H 17/14; C09D 5/08

(52) U.S. Cl. CPC E04H 17/1434; E04H 2017/1465; C09D 5/08; E04H 17/1421

(57) ABSTRACT

A panel for a fence includes elongated rail members and a post formed from first and second post members each of which has slots at spaced locations along the respective post member. The post members are interconnected in a post-forming condition in which the slots of one post member are aligned with those of the other so as to cooperate to form enclosed receptacles for carrying the rail members. The slots are generally semi-cordate shaped, and the slots of each post member have opposite orientation to the other, so as to enhance clamping of the rail member between the post members. There is also disclosed a method for forming such a panel for a fence.

### FIELD OF THE INVENTION

The present invention relates generally to a fence panel which can be assembled with other like panels in adjacent relation to one another to form a continuous fence, and more particularly to a structure and method of forming such a fence panel which includes components with corrosion-resistant coatings so as to resist atmospheric corrosion.

### BACKGROUND

As one example application of fence panels, fence panels for use in retaining cattle or other livestock within a designated area typically are made from black steel tubing, as termed in industry for tubing or piping from steel material which is not galvanized and which has a layer of iron oxide coating on its surface to provide mild corrosion resistance. The black steel tubing is cut to length for forming components of the fence panel, which are then interconnected in the prescribed arrangement by welding, and subsequently the interconnected components are painted or plated so as to seal the steel material against corrosion. However, particularly in the case of painting a fence panel to seal the material of same, an interior of the tubing forming the panel is not painted and thus these components tend to begin to corrode from their interior due to exposure to atmospheric moisture.

### SUMMARY OF THE INVENTION

It is one aspect of the invention there is provided a panel for a fence comprising:

a plurality of longitudinally elongated tubular rail members arranged in substantially parallel and spaced condition to one another;

each rail member comprising metallic material and having a corrosion-resistant coating applied to an interior surface of the rail member delimiting a longitudinally extending cavity of the tubular rail member;

at least one post carrying the rail members in said substantially parallel and spaced condition, each post being formed from first and second post members respectively extending longitudinally between a first end and a second end and having transversely opposite first and second sides, an inner side and an outer side opposite thereto;

each of the first and second post members defining a plurality of slots at longitudinally spaced locations along the post member, each slot extending transversely of the post member and being open (i) at its ends located at the first and second sides of the post member, and (ii) at the inner side of the post member along the length of the slot;

the first and second post members being interconnected in a post-forming condition with their inner sides generally facing one another and the slots of the first post member located in longitudinal alignment with the slots of the second post member so as to form a plurality of pairs of longitudinally aligned slots each cooperating to form an enclosed receptacle receiving one of the rail members in transverse orientation to the post members.

Thus is provided an arrangement which includes rail members having at least a corrosion-resistant interior surface arranged as such prior to assembly of the panel and which are connected to the supporting post in a manner which does not break its protective corrosion-resistant coating. Also, in this arrangement there is no welding required to connect the rail members to the post or post-forming members.

Preferably, each of the first and second post members are formed from metallic sheet material, with a corrosion-resistant coating applied thereto, formed into a channel which is open along its length and which includes a base wall and a pair of side walls supported on a common side of the base wall, the side walls defining pairs of transversely opposite cut-outs forming the slots of the post member. Thus, both an interior and exterior of the post members have corrosion-resistant coatings so as to be resistant to atmospheric corrosion.

In one arrangement, the slots of each of the first and second post members are substantially semi-cordate in transverse shape from a first side of the slot to a second side thereof, so that each slot includes a generally semi-circularly arcuate first portion extending from the first side of the slot which is at the inner side of the post member to an intermediary location between the first side of the slot and the second side of the slot which also is at the inner side of the post member, and a substantially linear second portion extending from the intermediary location to the second side of the slot, such that a transverse center of the first portion is angularly offset from a thickness direction oriented along a thickness of the post member measured from the outer side to the inner side.

Preferably, in such an arrangement, the slots of the first post member have inverted transverse shape relative to the slots of the second post member so that the centers of the first portions of each longitudinally aligned pair of slots are located on opposite sides of a thickness direction of the post which is measured between the outer sides of the post members in the post-forming condition, and the first and second post members are arranged so that in the post-forming condition the first and second sides of the first post member can be overlapped with the first and second sides of the second post member, such that in the post-forming condition each rail member is subjected to a clamping force by the post members exerted around a transverse periphery of the rail member.

Preferably, the second post member is arranged to receive in its inner side, in the post-forming condition, a portion of the thickness of the first post member at the inner side thereof, and the first post member is sized in exterior width from the first side to the second side thereof substantially equal to an interior width between the first and second sides of the second post member such that in the post-forming condition the first and second sides of the first post member are snugly received between the first and second sides of the second post member.

Preferably, the first and second post members are coupled to one another at locations which are offset from the slots thereof, relative to a longitudinal direction of the post members, so that the rail members are supported by clamping between the first and second post members.

Preferably, in the post-forming condition, the first and second post members are removably interconnected and the rail members are detachably supported in the receptacles.

Preferably, each rail member also has a corrosion-resistant coating applied to an exterior surface thereof.

It is another aspect of the invention to provide a post for carrying a plurality of elongated rails of a fence panel comprising:

first and second post members respectively extending longitudinally between a first end and a second end and having transversely opposite first and second sides, an inner side and an outer side opposite thereto;

each of the first and second post members defining a plurality of slots at longitudinally spaced locations along the post member, each slot extending transversely of the post member and being open (i) at its ends located at the first and second sides of the post member, and (ii) at the inner side of the post member along the length of the slot;

the slots of each of the first and second post members being substantially semi-cordate in transverse shape from a first side of the slot to a second side thereof, so that each slot includes a generally semi-circularly arcuate first portion extending from the first side of the slot which is at the inner side of the post member to an intermediary location between the first side of the slot and the second side of the slot which also is at the inner side of the post member, and a substantially linear second portion extending from the intermediary location to the second side of the slot, such that a transverse center of the first portion is angularly offset from a thickness direction oriented along a thickness of the post member measured from the outer side to the inner side; and

the first and second post members being interconnected in a post-forming condition with their inner sides generally facing one another and the slots of the first post member located in longitudinal alignment with the slots of the second post member so as to form a plurality of pairs of longitudinally aligned slots each cooperating to form an enclosed receptacle for receiving one of the rails in transverse orientation to the post members.

Preferably, the slots of the first post member have inverted transverse shape relative to the slots of the second post member so that the centers of the first portions of each longitudinally aligned pair of slots are located on opposite sides of a thickness direction of the post which is measured between the outer sides of the post members in the post-forming condition, and the first and second post members are arranged so that in the post-forming condition the first and second sides of the first post member can be overlapped with the first and second sides of the second post member, such that in the post-forming condition each rail member is subjected to a clamping force by the post members exerted around a transverse periphery of the rail member.

Preferably, the second post member is arranged to receive in its inner side, in the post-forming condition, a portion of the thickness of the first post member at the inner side thereof, and the first post member is sized in exterior width from the first side to the second side thereof substantially equal to an interior width between the first and second sides of the second post member such that in the post-forming condition the first and second sides of the first post member are snugly received between the first and second sides of the second post member.

Preferably, each of the first and second post members are formed from metallic sheet material, with a corrosion-resistant coating applied thereto, formed into a channel which is open along its length and which includes a base wall and a pair of side walls supported on a common side of the base wall, the side walls defining pairs of transversely opposite cut-outs forming the slots of the post member.

Preferably, the first and second post members are coupled to one another at locations which are offset from the slots thereof, relative to a longitudinal direction of the post members, so that the rail members are supported by clamping between the first and second post members.

It is yet another aspect of the invention to provide a method of forming a fence panel comprising:

providing a plurality of longitudinally elongated rail members;

providing a first post member which is longitudinally elongate and defines a plurality of transversely-extending slots at longitudinally spaced positions therealong that open at an inner side of the first post member;

providing a second post member connectable to the first post member at the inner side thereof in a post-forming condition for cooperating with the first post member to form, at the slots, a plurality of closed receptacles to receive the rail members in transverse orientation to the first post member;

locating the rail members in the slots of the first post member so that the rail members are arranged in substantially parallel and spaced condition to one another, and in transverse orientation to the first post member; and

after the rail members are located in the slots of the first post member, arranging the second post member in the post-forming condition relative to the first post member and coupling the second post member to the first post member at locations which are offset from the slots relative to a longitudinal direction of the first post member so as to clamp the rails between the first and second post members.

Preferably, substantially all surfaces of the provided first and second post members have a corrosion-resistant coating applied thereto, and the provided rail members comprise metallic tubing having a corrosion-resistant coating applied to an interior surface delimiting a longitudinally extending cavity of the tubing.

Preferably, the provided rail members also have a corrosion-resistant coating applied to exterior surfaces thereof.

In one arrangement, during locating the rail members in the slots of the first post member, the first post member is oriented substantially upright and the rail members are supported by gravity in downwardly and horizontally extending portions of the slots of the first post member.

### BRIEF DESCRIPTION OF THE DRAWINGS

The invention will now be described in conjunction with the accompanying drawings in which:

FIG. 1 is a front view of an arrangement of panel and post for a fence according to the present invention;

FIG. 2 is an end view showing the arrangement of FIG. 1 both in an exploded condition and a post-forming condition;

FIG. 3 is an enlarged view of the area indicated at I in FIG. 2;

FIG. 4 is a top view of a portion of the arrangement of FIG. 1;

FIG. 5 is an enlarged side view of a first post member of the arrangement of FIG. 1;

FIG. 6 is an enlarged side view of a second post member of the arrangement of FIG. 1;

FIG. 7 is a plan view of a post member of the arrangement of FIG. 1;

FIG. 8 is an exploded perspective view of the arrangement of FIG. 1 showing only a portion of the panel; and

FIG. 9 is a partially exploded perspective view of the arrangement of FIG. 1.

In the drawings like characters of reference indicate corresponding parts in the different figures.

### DETAILED DESCRIPTION

In the accompanying figures is shown a panel 10 for a fence which can be assembled with other like panels in adjacent and substantially contiguous relation to form a continuous fence for separating one outdoor area from another or for enclosing an outdoor area. In some applications the fence segregates or confines animals or livestock to the designated outdoor area. Thus the panel is exposed to atmospheric conditions such as moisture, and as such panels typically are made from metallic material such as steel so as to be of sufficient strength they are consequently normally susceptible to corrosion, particularly in the form of oxidation occurring due to exposure to moisture.

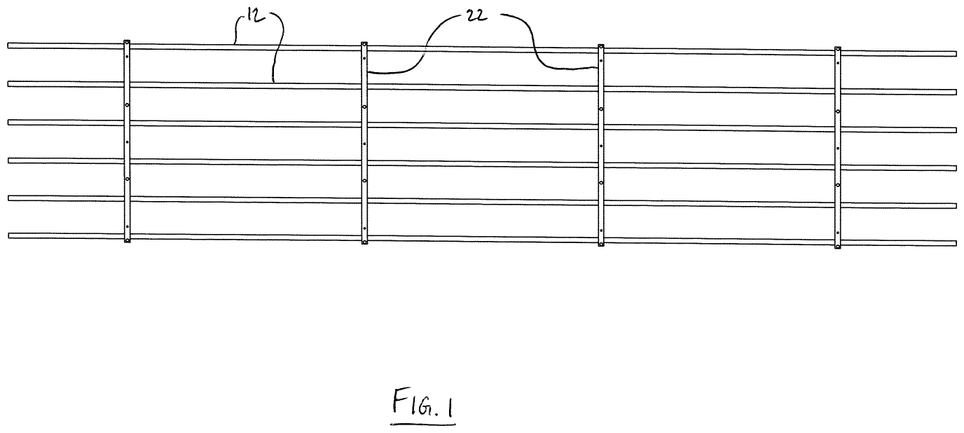

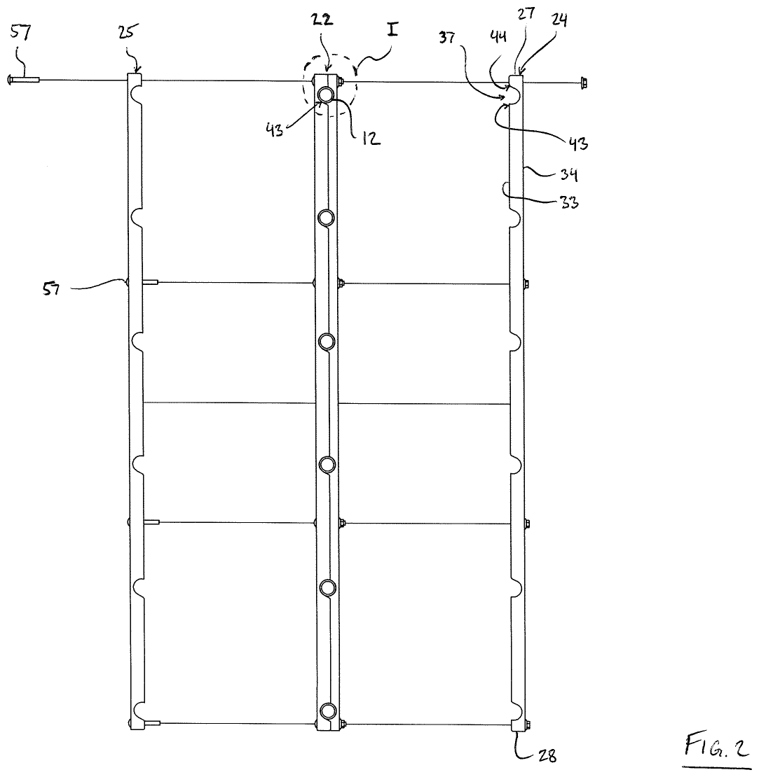

Referring to FIGS. 1 and 2, the panel 10 comprises a plurality of longitudinally elongated tubular rail members 12 arranged in substantially parallel and spaced condition to one another. Each rail member 12 is oriented generally horizontally and thus the plurality of rail members are spaced generally vertically from one another.

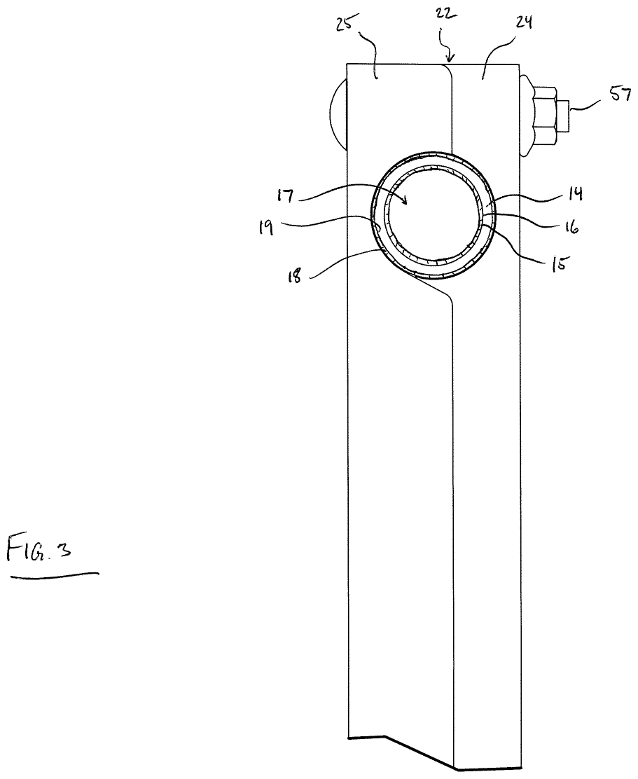

As more clearly shown in FIG. 3, each rail member 12 comprises metallic material 14 and has a corrosion-resistant coating 15 (schematically shown) applied to an interior surface 16 of the rail member delimiting a longitudinally extending cavity 17 of the tubular rail member. That is, the rail member 12 is made from metallic material or more specifically from metallic tubing, which is susceptible to corrosion, and thus the interior surface of the rail member includes a coating 15 thereon to resist initiation of corrosion at an inside or interior of the tubular rail member. The corrosion-resistant coating is applied to the interior of the rail member prior to assembly of the panel, as will be described in more detail shortly. Typically the rail member 12 also has a corrosion-resistant coating 18 (schematically shown) applied to an exterior surface 19 thereof, also prior to assembly of the panel, such that the rail member is substantially wholly covered with corrosion-resistant coating in order to resist both interior and exterior initiation of corrosion of the rail member.

The panel 10 also includes at least one post 22 carrying the rail members 12 in the substantially parallel and spaced condition. Each post is oriented substantially vertically upright so as to carry the generally horizontally-oriented rail members in spaced vertical relation to one another.

As more clearly shown in FIGS. 2-4, each post 22 is formed from first and second post members 24, 25 respectively extending longitudinally between a first end 27 and a second end 28, and having transversely opposite first and second sides 31 and 32, an inner side 33 and an outer side 34 opposite thereto. Each post member is linearly elongated between its longitudinally opposite ends 27, 28 and is substantially rectanguloid in three-dimensional shape.

Each post member 24 or 25 defines a plurality of slots 37 at longitudinally spaced locations along the post member. Each slot 37 extends transversely of the post member and is open both at its ends 39, 40 located at the first and second sides 31, 32 of the post member, and at the inner side 33 of the post member along the length of the slot. Thus the slot 37 can receive the rail member 12 oriented transversely or cross-wise to the post member displaced into the slot in a direction transverse to the rail member 12.

To form the post 22, the first and second post members 24, 25 are interconnected in a post-forming condition as more clearly shown in FIG. 2 with their inner sides 33 generally facing one another and the slots 37 of the first post member 24 located in longitudinal alignment with the slots of the second post member 25 so as to form a plurality of pairs of longitudinally aligned slots cooperating to form an enclosed receptacle 43 receiving one of the rail members 12 in transverse orientation to the post members. That is, in the post-forming condition, the post members 24, 25 are mated in a manner in which each longitudinally pair of their slots 37 collectively forms a circumferentially enclosed receptacle which surrounds a transverse periphery or circumference of the rail member for carrying same and which confines the rail member against movement radially of a longitudinal axis thereof. In the post-forming condition the post members 24, 25 are substantially parallel to one another, and they are mated by relative movement of one post member to the other in a transverse direction which is parallel to their thicknesses between their inner and outer sides 33, 34.

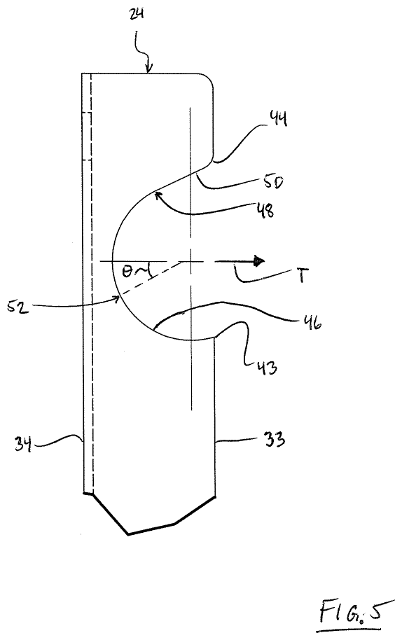

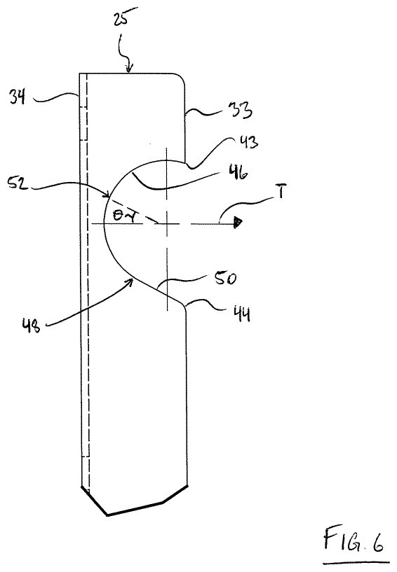

In the illustrated arrangement, as shown in FIG. 2, the slots 37 of each of the first and second post members 24, 25 are substantially semi-cordate in transverse or side-to-side shape from a first side 43 of the slot to a second side 44 thereof which are spaced apart in a longitudinal direction of the respective post member. In other words, each slot is generally shaped like half of a heart. Each slot 37 thus includes, as more clearly shown in FIGS. 5 and 6, a generally semi-circularly arcuate first portion 46 extending from the first side 43 of the slot which is at the inner side 33 of the post member to an intermediary location 48 between the first side 43 of the slot and the second side 44 of the slot which also is at the inner side of the post member. Additionally to the semi-circularly arcuate first portion 46 is provided a substantially linear second portion 50 extending from the intermediary location 48 to the second side 44 of the slot. Thus, a transverse center 52 of the first portion 46 is angularly offset by angle θ from a thickness direction T of the post member which is oriented along a thickness of the post member measured from the outer side 34 to the inner side 33. All of the slots of a common post member are oriented in the same fashion such that the semi-circular first portion 46 is located to the same side of the linear second portion 50 for each slot 37.

However, the slots of the first post member 24 have inverted transverse shape relative to the slots of the second post member 25 as shown in FIG. 2 or upon juxtaposition of FIGS. 5 and 6, so that the centers 48 of the first portions of each longitudinally aligned pair of slots are located on opposite sides of a thickness direction of the post which is measured between the outer sides 34 of the post members 24, 25 in the post-forming condition, and which is parallel to the thickness direction T. Thus, even though the slots themselves are generally semi-cordate shaped, they form a generally circular receptacle 43 in the post-forming condition to match the circular cross-sectional shape of the rail members. Typically, the first post member 24 is oriented so that the semi-circular portions 46 of the slots are below the linear portions 50 so that the rail members 12 can be supported by gravity in the semi-circular portions 46, at which the slots of the first post member extending downwardly and horizontally, without intimate presence of the second post member to confine the rail member to the slots 37 of the first post member. The second post member 25 is then oriented opposite to the first post member so that its slots' semi-circular portions 46 are disposed above the linear portion 50.

Furthermore, the first and second post members 24, 25 are arranged so that in the post-forming condition the first and second sides 31, 32 of the first post member can be overlapped with the first and second sides of the second post member 25, such that in the post-forming condition each rail member 12 is subjected to a clamping force by the post members exerted around the transverse periphery of the rail member. That is, when the post members 24, 25 are interconnected, they can be brought closer together in effect making the receptacles 43 smaller in size but as this relative movement takes place primarily in a direction parallel to the thickness direction T, the angularly offset center 52 of the semi-circular portion 46 of the slot which substantially cradles and conforms to the contour of the rail member acts to exert a clamping force around the full circumference of the rail member as opposed to being substantially localized at points lying along the thickness direction T.

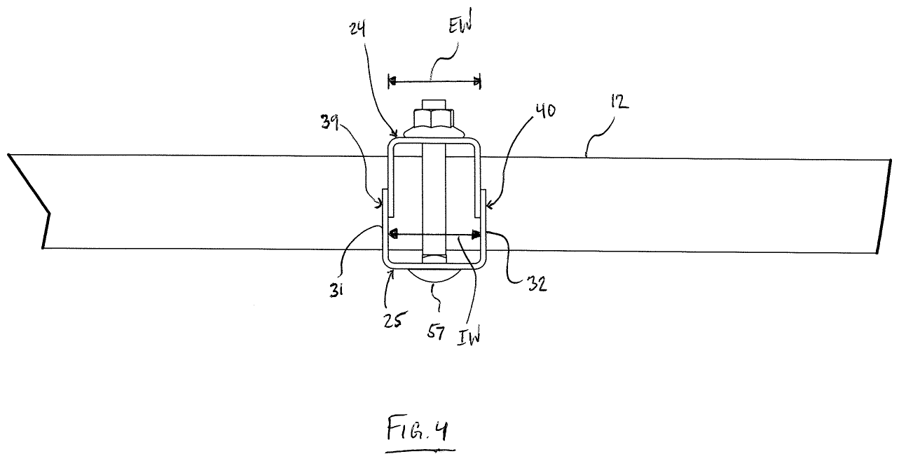

For the overlapping arrangement, the second post member 25 is arranged to receive in its inner side 33, in the post-forming condition, a portion of the thickness of the first post member 24 at the inner side 33 thereof. As such, in the illustrated arrangement the second post member 25 forms a longitudinally extending channel at the inner side 33 that is open thereat so as to accept a partial thickness of the first post member across the full length of the first post member. Furthermore, the first post member 24 is sized in exterior width EW from the first side 31 to the second side 32 thereof substantially equal to an interior width IW between the first and second sides of the second post member 25 such that in the post-forming condition the first and second sides of the first post member are snugly received between the first and second sides of the second post member, as more clearly shown in FIG. 4.

As more clearly shown in FIG. 2, the first and second post members 24, 25 are coupled to one another to form the post at locations represented by fasteners 57 which are offset from the slots 37, relative to a longitudinal direction of the respective post member, thereof so that the rail members 12 are supported by clamping between the first and second post members. That is, the interconnection locations by which the post members are joined do not pass through the rail members, and carriage of the rail members 12 in the receptacles is independent of the interconnection arrangement used to hold the post members in the post-forming condition. The apertures defined in the outer sides 34 of the post members for passing the interconnection fasteners 57 therethrough are preformed prior to the assembly process.

As such, in the post-forming condition, the first and second post members 24, 25 are removably interconnected, so as to be separable, and the rail members 12 are detachably supported in the receptacles 43.

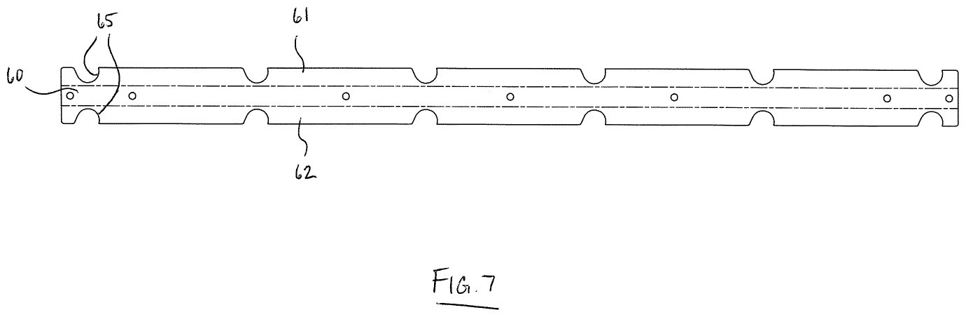

As shown in FIG. 7, each post member 24 or 25 is formed from metallic sheet material, with a corrosion-resistant coating applied thereto on first and second opposite faces thereof (only one of which is shown in FIG. 7), which sheet material is formed into a channel that is open along its length between ends 27, 28 and which includes a base wall 60 and a pair of side walls 61, 62 supported on a common side of the base wall so as to generally form a U or C-shape in cross-section. The side walls 61, 62 define pairs of transversely opposite cut-outs 65 forming the slots 37 of the post member. Thus, both interior and exterior surfaces of the post members have corrosion-resistant coatings so as to be resistant to atmospheric corrosion.

In the illustrated arrangement, the corrosion-resistant coatings applied to the rail members and to the post members are formed by galvanization such that both the rail members and the post members each have a galvanized interior surface and a galvanized exterior surface. Preferably the whole of each of these components is coated so as to be substantially corrosion-resistant.

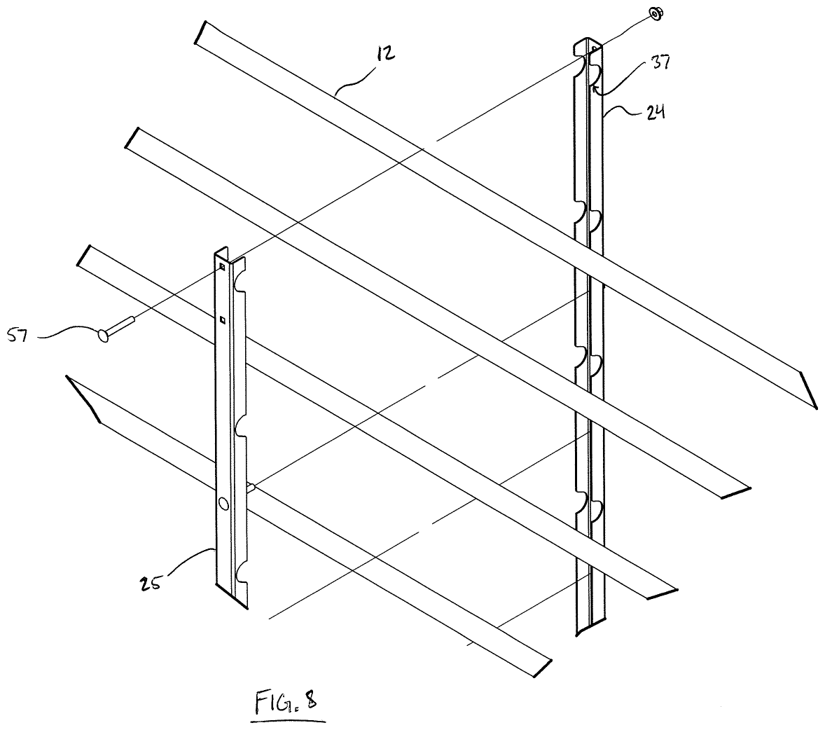

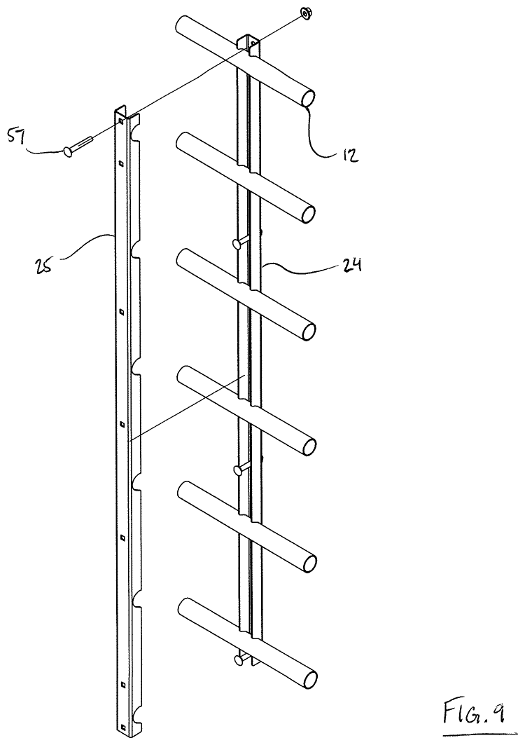

Turning now to FIGS. 8 and 9, to form the panel 10, firstly, the rail members 12 and the first and second post members 24, 25 for forming the respective post 22 are provided, each with corrosion-resistant coatings on the prescribed surfaces. The second post member generally functions as a member connectable to the first post member at the inner side thereof in a post-forming condition for cooperating with the first post member to form, at the slots, a plurality of closed receptacles to receive the rail members in transverse orientation to the first post member. The post members may be provided as the metallic sheet material which is subsequently formed into the channel with the cut-outs forming the slots.

Next, the rail members 12 are located in the slots 37 of the first post member 24 so that the rail members are arranged in substantially parallel and spaced condition to one another, and in transverse orientation to the first post member. In this step, the first post member 24 is oriented substantially upright and the rail members 12 are supported by gravity in downwardly and horizontally extending portions of the slots, indicated at 46, of the first post member in absence of the second post member 25.

After the rail members 12 are located in the slots 37 of the first post member 24, the second post member 25 is arranged in the post-forming condition relative to the first post member 24, and furthermore is coupled to the first post member at locations 57 which are offset from the slots 37 relative to a longitudinal direction of the first post member, so as to clamp the rails between the first and second post members.

Thus is formed a panel which is substantially corrosion-resistant because the rail members and the posts are substantially corrosion-resistant, and the process of interconnecting these components enables them to be provided with their corrosion-resistant coatings prior to assembly because the assembly process does not damage these coatings.

Thus is provided an arrangement which includes rail members having at least a corrosion-resistant interior surface arranged as such prior to assembly of the panel and which are connected to the supporting post in a manner which does not break its protective corrosion-resistant coating. Also, in this arrangement there is no welding required to connect the rail members to the post or post-forming members.

The rail members and the post members may be provided as a kit for subsequent assembly on site where the fencing is to be installed.

The posts formed by interconnected post members simply act to bridge between adjacent rail members to carry them in their spaced arrangement and are not mounted into the ground or in any other manner which supports the panel in an upright condition.

In other arrangements which are not shown, the first and second post members 24, 25 may have the same interior and exterior widths IW, EW so that in the post forming condition, instead of the first and second sides of the first post member 24 being snugly received between the first and second sides of the second post member as in the illustrated arrangement, the post members 24, 25 are transversely offset from one another with the first side of the first post member received intermediate the first and second sides of the second post member, but preferably being located in intimate relation with an inner face of one of the sides of the second post member, and the second side of the first post member being located externally of the second post member preferably in intimate relation with an outer face of the opposite side thereof. In such an arrangement the first and second post members are basically identical which may reduce manufacturing costs.

The scope of the claims should not be limited by the preferred embodiments set forth in the examples but should be given the broadest interpretation consistent with the specification as a whole.

1. A panel for a fence comprising:
a plurality of longitudinally elongated tubular rail members arranged in substantially parallel and spaced condition to one another;
each rail member comprising metallic material and having a corrosion-resistant coating applied to an interior surface of the rail member delimiting a longitudinally extending cavity of the tubular rail member;
at least one post carrying the rail members in said substantially parallel and spaced condition, each post being formed from first and second post members respectively extending longitudinally between a first end and a second end and having transversely opposite first and second sides, an inner side and an outer side opposite thereto;
each of the first and second post members defining a plurality of slots at longitudinally spaced locations along the post member, each slot extending transversely of the post member and being open (i) at its ends located at the first and second sides of the post member, and (ii) at the inner side of the post member along the length of the slot;
the first and second post members being interconnected in a post-forming condition with their inner sides generally facing one another and the slots of the first post member located in longitudinal alignment with the slots of the second post member so as to form a plurality of pairs of longitudinally aligned slots each cooperating to form an enclosed receptacle receiving one of the rail members in transverse orientation to the post members.

2. The panel of claim 1 wherein each of the first and second post members are formed from sheet material, with a corrosion-resistant coating applied thereto, formed into a channel which is open along its length and which includes a base wall and a pair of side walls supported on a common side of the base wall, the side walls defining pairs of transversely opposite cut-outs forming the slots of the post member.

3. The panel of claim 1 wherein the slots of each of the first and second post members are substantially semi-cordate in transverse shape from a first side of the slot to a second side thereof, so that each slot includes a generally semi-circularly arcuate first portion extending from the first side of the slot which is at the inner side of the post member to an intermediary location between the first side of the slot and the second side of the slot which also is at the inner side of the post member, and a substantially linear second portion extending from the intermediary location to the second side of the slot, such that a transverse center of the first portion is angularly offset from a thickness direction oriented along a thickness of the post member measured from the outer side to the inner side.

4. The panel of claim 3 wherein the slots of the first post member have inverted transverse shape relative to the slots of the second post member so that the centers of the first portions of each longitudinally aligned pair of slots are located on opposite sides of a thickness direction of the post which is measured between the outer sides of the post members in the post-forming condition, and the first and second post members are arranged so that in the post-forming condition the first and second sides of the first post member can be overlapped with the first and second sides of the second post member, such that in the post-forming condition each rail member is subjected to a clamping force by the post members exerted around a transverse periphery of the rail member.

5. The panel of claim 1 wherein the second post member is arranged to receive in its inner side, in the post-forming condition, a portion of the thickness of the first post member at the inner side thereof, and the first post member is sized in exterior width from the first side to the second side thereof substantially equal to an interior width between the first and second sides of the second post member such that in the post-forming condition the first and second sides of the first post member are snugly received between the first and second sides of the second post member.

6. The panel of claim 1 wherein the first and second post members are coupled to one another at locations which are offset from the slots thereof, relative to a longitudinal direction of the post members, so that the rail members are supported by clamping between the first and second post members.

7. The panel of claim 1 wherein, in the post-forming condition, the first and second post members are removably interconnected and the rail members are detachably supported in the receptacles.

8. The panel of claim 1 wherein each rail member also has a corrosion-resistant coating applied to an exterior surface thereof.

9. A post for carrying a plurality of elongated rails of a fence panel comprising:
first and second post members respectively extending longitudinally between a first end and a second end and having transversely opposite first and second sides, an inner side and an outer side opposite thereto;
each of the first and second post members defining a plurality of slots at longitudinally spaced locations along the post member, each slot extending transversely of the post member and being open (i) at its ends located at the first and second sides of the post member, and (ii) at the inner side of the post member along the length of the slot;
the slots of each of the first and second post members being substantially semi-cordate in transverse shape from a first side of the slot to a second side thereof, so that each slot includes a generally semi-circularly arcuate first portion extending from the first side of the slot which is at the inner side of the post member to an intermediary location between the first side of the slot and the second side of the slot which also is at the inner side of the post member, and a substantially linear second portion extending from the intermediary location to the second side of the slot, such that a transverse center of the first portion is angularly offset from a thickness direction oriented along a thickness of the post member measured from the outer side to the inner side; and
the first and second post members being interconnected in a post-forming condition with their inner sides generally facing one another and the slots of the first post member located in longitudinal alignment with the slots of the second post member so as to form a plurality of pairs of longitudinally aligned slots each cooperating to form an enclosed receptacle for receiving one of the rails in transverse orientation to the post members.

10. The post of claim 9 wherein the slots of the first post member have inverted transverse shape relative to the slots of the second post member so that the centers of the first portions of each longitudinally aligned pair of slots are located on opposite sides of a thickness direction of the post which is measured between the outer sides of the post members in the post-forming condition, and the first and second post members are arranged so that in the post-forming condition the first and second sides of the first post member can be overlapped with the first and second sides of the second post member, such that in the post-forming condition each rail member is subjected to a clamping force by the post members exerted around a transverse periphery of the rail member.

11. The post of claim 9 wherein the second post member is arranged to receive in its inner side, in the post-forming condition, a portion of the thickness of the first post member at the inner side thereof, and the first post member is sized in exterior width from the first side to the second side thereof substantially equal to an interior width between the first and second sides of the second post member such that in the post-forming condition the first and second sides of the first post member are snugly received between the first and second sides of the second post member.

12. The post of claim 9 wherein each of the first and second post members are formed from metallic sheet material, with a corrosion-resistant coating applied thereto, formed into a channel which is open along its length and which includes a base wall and a pair of side walls supported on a common side of the base wall, the side walls defining pairs of transversely opposite cut-outs forming the slots of the post member.

13. The post of claim 9 wherein the first and second post members are coupled to one another at locations which are offset from the slots thereof, relative to a longitudinal direction of the post members, so that the rail members are supported by clamping between the first and second post members.

14. A method of forming a fence panel comprising:
providing a plurality of longitudinally elongated rail members;
providing a first post member which is longitudinally elongate and defines a plurality of transversely-extending slots at longitudinally spaced positions therealong that open at an inner side of the first post member;
providing a second post member connectable to the first post member at the inner side thereof in a post-forming condition for cooperating with the first post member to form, at the slots, a plurality of closed receptacles to receive the rail members in transverse orientation to the first post member;
locating the rail members in the slots of the first post member so that the rail members are arranged in substantially parallel and spaced condition to one another, and in transverse orientation to the first post member; and
after the rail members are located in the slots of the first post member, arranging the second post member in the post-forming condition relative to the first post member and coupling the second post member to the first post member at locations which are offset from the slots relative to a longitudinal direction of the first post member so as to clamp the rails between the first and second post members.

15. The method of claim 14 wherein substantially all surfaces of the provided first and second post members have a corrosion-resistant coating applied thereto, and the provided rail members comprise metallic tubing having a corrosion-resistant coating applied to an interior surface delimiting a longitudinally extending cavity of the tubing.

16. The method of claim 15 wherein the provided rail members also have a corrosion-resistant coating applied to exterior surfaces thereof.

17. The method of claim 14 wherein, during locating the rail members in the slots of the first post member, the first post member is oriented substantially upright and the rail members are supported by gravity in downwardly and horizontally extending portions of the slots of the first post member.
